(19) United States
(12) Patent Application Publication
(10) Pub. No.: US 2017/0163210 A1
(43) Pub. Date: Jun. 8, 2017

(54) PHOTOVOLTAIC MODULE

(71) Applicant: Lee Gorny, Mountain View, CA (US)

(72) Inventor: Lee Gorny, Mountain View, CA (US)

(21) Appl. No.: 14/962,917

(22) Filed: Dec. 8, 2015

(51) Int. Cl. H02S 30/10

(52) U.S. Cl. CPC H02S 30/10

(57) ABSTRACT

Various improved approaches to ensure proper alignment of a photovoltaic (PV) laminate with a frame and prevent PV module structural defects are described herein. PV laminate-constraining devices, or clips, can inhibit physical deformation of a PV laminate during manufacturing, shipping, and/or installation. PV laminate-constraining features and devices can direct adhesive regions into desired locations and/or inhibit displacement of adhesives during PV module manufacturing.

### BACKGROUND

Photovoltaic (PV) cells, commonly known as solar cells, are devices for conversion of solar radiation into electrical energy. Generally, solar radiation impinging on the surface of, and entering into, the substrate of a solar cell creates electron and hole pairs in the bulk of the substrate. The electron and hole pairs migrate to p-doped and n-doped regions in the substrate, thereby creating a voltage differential between the doped regions. The doped regions are connected to the conductive regions on the solar cell to direct an electrical current from the cell to an external circuit. When PV cells are combined in an array such as a PV module, the electrical energy collected from all of the PV cells can be combined in series and parallel arrangements to provide power with a certain voltage and current.

PV modules can include PV laminates typically comprised of glass, PV cells, conductive material for circuit formation and insulating material to encapsulate the circuit and prevent electrical energy from escaping the circuit. PV laminates often utilize support structures, or frames, for maintaining the structural integrity of the PV module. PV module frames can constrain the PV laminate's position relative to the installation surface (e.g., penetrating-type mounting in which bolts are driven through the rooftop to attach the framework and/or auxiliary connectors to the rooftop; non-penetrating mounting in which auxiliary components interconnect PV modules to one another, etc.). Thus, some traditional PV modules employ an extruded aluminum frame that supports the entire perimeter of the corresponding PV laminate. A lip of the aluminum frame can extend over and capture an upper and lower surfaces of the PV laminate. Proper bonding and alignment between frame and laminate during manufacturing can prevent structural defects, stabilize the PV module to environmental conditions and transportation, and improve aesthetic value of the PV module.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are not drawn to scale.

FIG. 1 illustrates a photovoltaic (PV) module according to an embodiment;

FIG. 2 illustrates an exploded cross-sectional view of a section of PV module according to an embodiment;

FIG. 3 illustrates a laminate-constraining clip according to an embodiment;

FIG. 4 illustrates a laminate-constraining clip according to an embodiment;

FIG. 5 illustrates a laminate-constraining clip according to an embodiment;

FIG. 6 illustrates a laminate-constraining clip according to an embodiment;

FIG. 7 illustrates a ribbed laminate-constraining clip according to an embodiment;

FIG. 8 illustrates a ribbed laminate-constraining clip according to an embodiment;

FIG. 9 illustrates a cross-sectional view of a section of a PV module according to an embodiment;

FIG. 10 illustrates a cross-sectional view of PV module according to an embodiment;

FIGS. 11A and 11B illustrate a PV laminate according to an embodiment;

FIG. 12 illustrates a cross-sectional view of PV module according to an embodiment;

FIG. 13 illustrates a cross-sectional view of PV module according to an embodiment;

FIG. 14 illustrates a flow chart for manufacturing a PV module according to an embodiment.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Terminology—The following paragraphs provide definitions and/or context for terms found in this disclosure (including the appended claims):

This specification includes references to “one embodiment” or “an embodiment.” The appearances of the phrases “in one embodiment” or “in an embodiment” do not necessarily refer to the same embodiment. Particular features, structures, or characteristics can be combined in any suitable manner consistent with this disclosure.

This term “comprising” is open-ended. As used in the appended claims, this term does not foreclose additional structure or steps.

Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

As used herein, the terms “first,” “second,” etc. are used as labels for nouns that they precede, and do not imply any type of ordering (e.g., spatial, temporal, logical, etc.). For example, reference to a “first” encapsulant layer does not necessarily imply that this encapsulant layer is the first encapsulant layer in a sequence; instead the term “first” is used to differentiate this encapsulant from another encapsulant (e.g., a “second” encapsulant).

The terms “a” and “an” are defined as one or more unless this disclosure explicitly requires otherwise.

The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

As used herein, “inhibit” is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

As used herein, the term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

As used herein, “regions” can be used to describe discrete areas, volumes, divisions or locations of an object or material having definable characteristics but not always fixed boundaries.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present invention. The feature or features of one embodiment can be applied to other embodiments, even though not described or illustrated, unless expressly prohibited by this disclosure or the nature of the embodiments.

To maintain structural integrity of a photovoltaic (PV) module, edges of a PV laminate can be mounted with a support structure or a frame. In the manufacture of a PV module, an adhesive can be used to bond the PV laminate to a frame. Various improved approaches to ensure proper alignment of the PV laminate with the frame, desired bonding characteristics and prevent structural defects are described herein. Laminate-constraining devices, or clips, can inhibit physical deformation of a PV laminate during manufacturing, shipping, and/or installation. Laminate-constraining devices, or clips can direct the adhesive regions into desired locations and/or inhibit displacement of adhesives during manufacturing e.g. bonding a PV laminate to a support structure, or frame. Various embodiments of the present invention will now be disclosed.

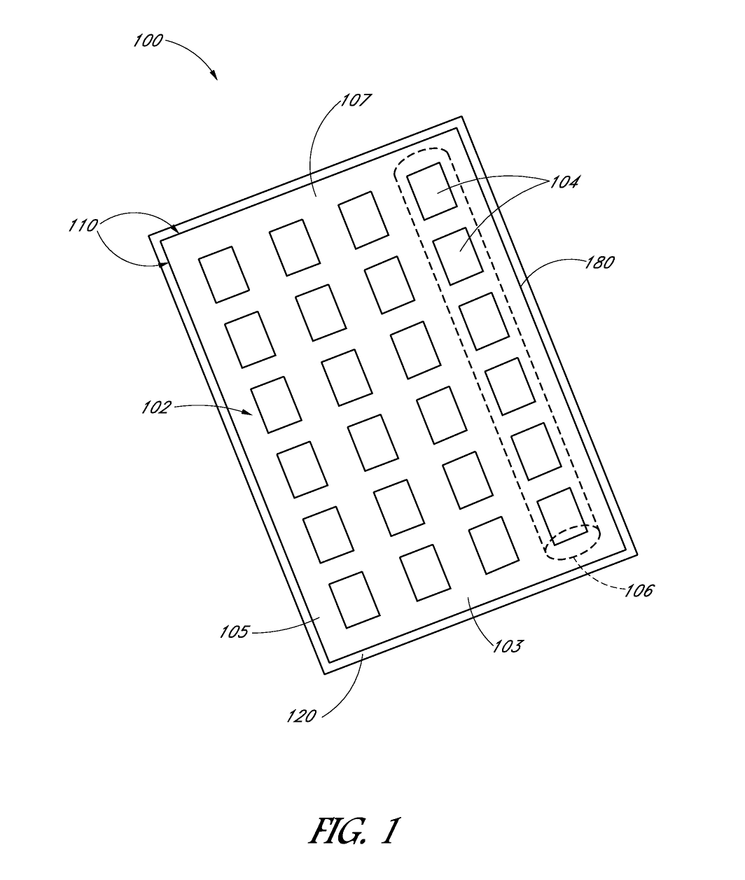

In the embodiment depicted in FIG. 1, a PV module 100 comprises a PV laminate 102 surrounded by a frame 120. The PV laminate 102 comprises a plurality of PV cells 104 connected to form a PV cell string 106. The PV laminate 102 can further comprise a transparent cover 103, a back sheet 105 and an encapsulant 107 encapsulating the plurality of PV cells 104 between the transparent cover 103 and the back sheet 105. The PV laminate 102 can have peripheral edges 108 defining a laminate perimeter generally depicted at 110. The frame 120 can extend continuously along the laminate perimeter. An adhesive 180 can extend along the laminate perimeter between the peripheral edges 108 of the PV laminate 102 and the frame 120.

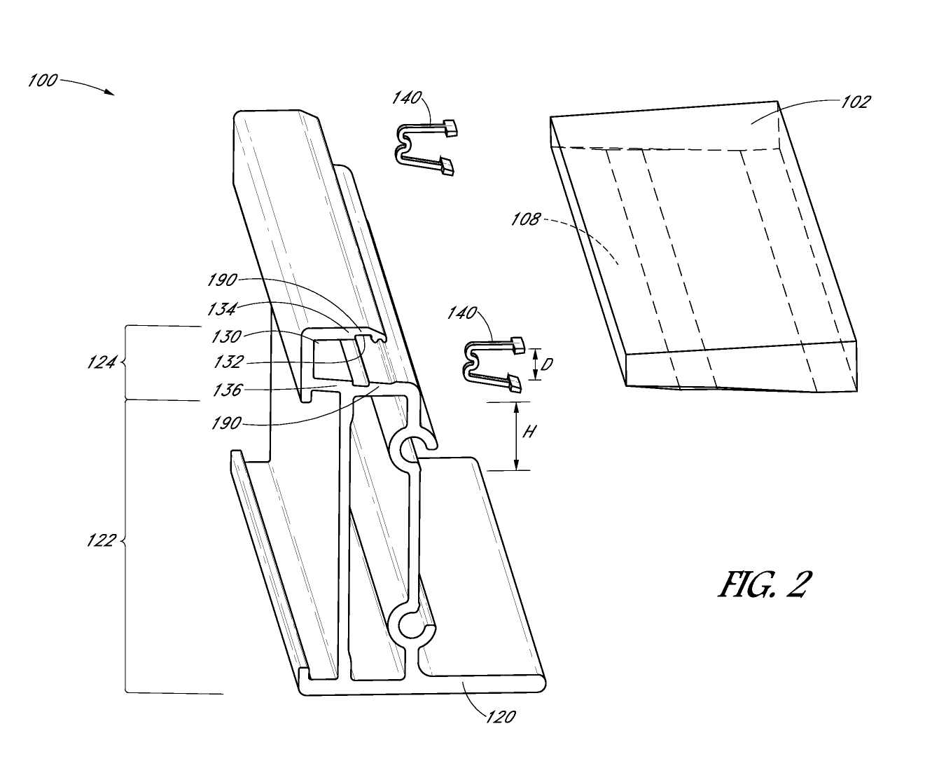

An exploded cross-sectional view of a section of PV module 100 is depicted in FIG. 2. The frame 120 comprises a lower base portion 122 and an upper portion 124. The upper portion 124 comprises a laminate-receiving channel 130. The laminate-receiving channel 130 comprises an upper channel flange 134, a lower channel flange 136 and a channel recess 132 defined between the upper and lower channel flanges 134, 136.

In one embodiment, a laminate-receiving channel is substantially planar, and in other embodiments the laminate-receiving channel can have surface features. For example, surface features of the laminate-receiving channel can comprise longitudinally extending ridges, longitudinally extending recesses, sinusoidal cross sections, saw-tooth cross sections, or derivatives thereof. In one embodiment, channel surface features comprise. In the example of FIG. 2, the channel 130 of frame 120 comprises a plurality of ridges 190 extending along a longitudinal direction of a peripheral edge 108 of a PV laminate 102.

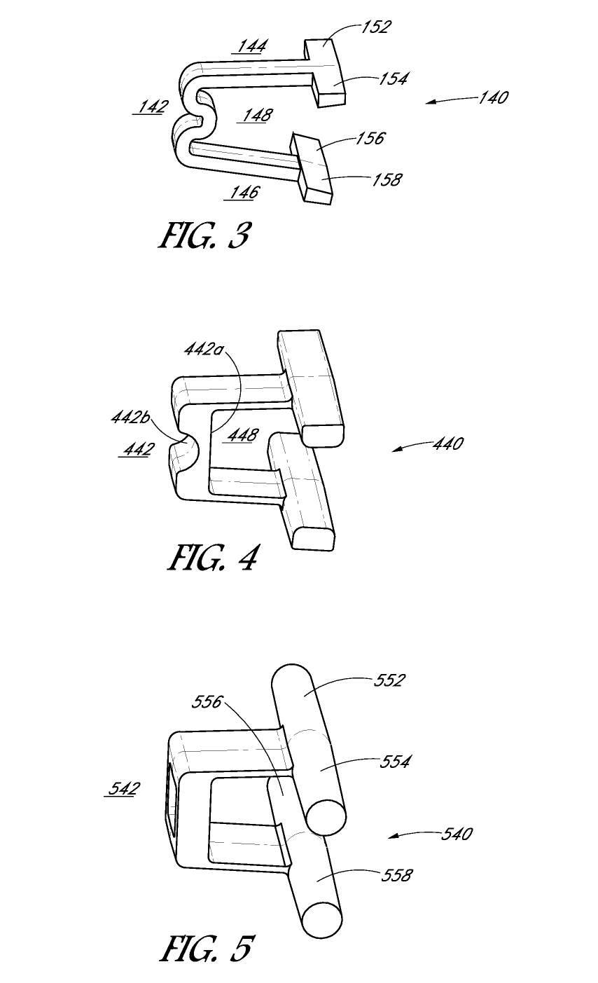

In FIG. 2, a plurality of laminate-constraining clips 140 are positioned between the peripheral edge 108 of PV laminate 102 and the frame 120. A magnified view of laminate-constraining clip 140 is depicted in FIG. 3. The laminate-constraining clip 140 comprises a clip mid-section 142, an upper clip arm 144 and, a lower clip arm 146. The clip mid-section 142 connects the upper clip arm 144 to the lower clip arm 146 to define clip concavity 148. The laminate-constraining clip 140 comprises a mid-section 142 having a sinusoidal shape.

In an embodiment, laminate-constraining clips comprise a compressible feature. In one embodiment, the compressible feature can be integrally formed with the laminate constraining clip such that the laminate-constraining clip is formed or molded as a single component. In other embodiments, the compressible feature can be formed separately from the laminate-constraining clip and then subsequently coupled to the laminate-constraining clip. Non-limiting examples of the compressible feature include a compressible polymer material, a metallic wire, a spring tensioned structure, a sinusoidal shaped structure, a W-shaped structure, a U-shaped structure, an S-shaped structure, an X-shaped structure, a spiral structure, a coil, a spring, or a combination thereof.

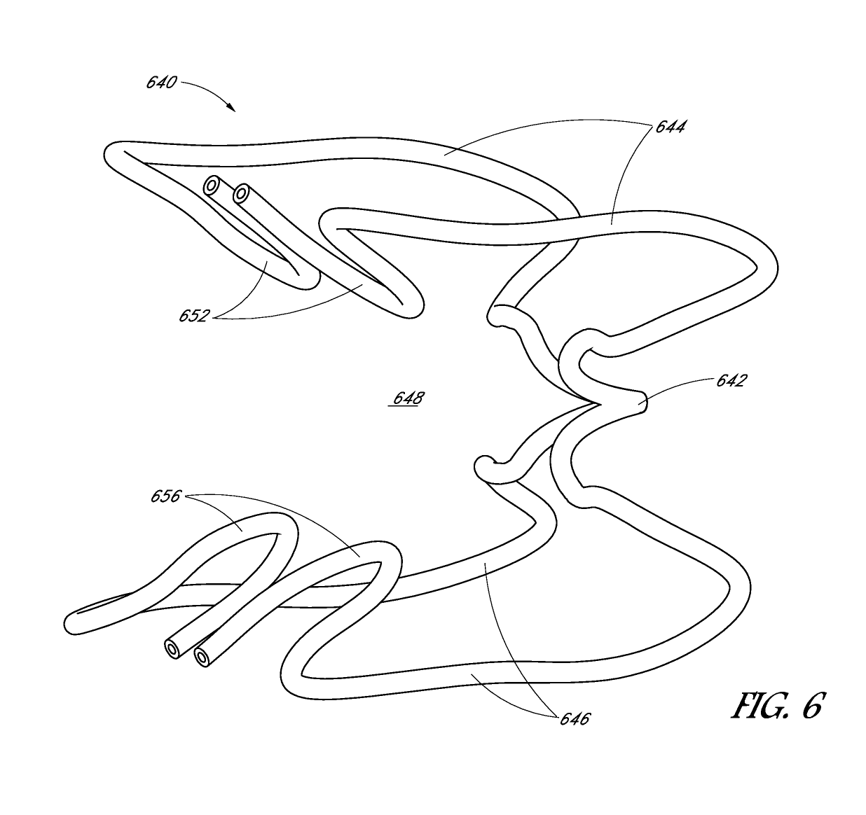

FIGS. 4-6 illustrate various embodiments of laminate-constraining clips. Unless otherwise specified below, the numerical indicators used to refer to components in FIGS. 4-6 are similar to those used to refer to components or features in FIGS. 1-3 above, except that the index has been incremented by 100.

In the illustrated embodiment of FIG. 4, clip 440 comprises a mid-section 442 having a substantially planar surface 442a facing clip concavity 448 and a U-shaped surface 442b opposite the substantially planar surface 442a. In the illustrated embodiment of FIG. 5, clip 540 comprises a mid-section 542 having substantially planar surfaces.

In some embodiments, the clip comprises a projection. In the exemplary embodiment of FIG. 3, the upper clip arm 144 comprises a first upper clip arm projection 152 and a second upper clip arm projection 154. The lower clip arm 146 comprises a first lower clip arm projection 156 and a second lower clip arm projection 158. In one embodiment, first and second clip arm projections extend in opposite directions and are substantially parallel, or at approximately 180° relative to each other. In other embodiments, a plurality of projections can extend at angles greater or less than 180° relative to each other. As depicted in FIG. 3, the upper clip arm projections 152, 154 and the lower clip projections 156, 158 are substantially perpendicular to the upper clip arm 144 and lower clip arm 146, respectively. However in other embodiments, clip projections can extend at angles greater or less than 90° relative to the arm from which the projection extends.

In an embodiment, clip projections can extend parallel to a peripheral edge of the PV laminate. For example, in the illustration of FIG. 2 and FIG. 3, upper clip arm projections 152, 154 and lower clip arm projections 156, 158 are substantially parallel to the peripheral edge 108 of the PV laminate 102.

In the embodiment illustrated in FIG. 3, upper clip arm projections 152, 154 and lower clip arm projections 156, 158 are substantially rectangular. However, clip projections can be provided in any desirable shape including cylindrical, triangular, rounded, pointed, etc. As depicted in FIG. 4, upper clip arm projections 452, 454 and lower clip arm projections 456, 458 comprise rounded surfaces facing clip concavity 448 and substantially rectangular outer surfaces opposite clip concavity 448. As another example, clip 540 of FIG. 5 comprises substantially cylindrical upper clip arm projections 552, 554 and lower clip arm projections 556, 558.

In one embodiment, a clip comprises metallic elements and/or other flexible materials. For example, a clip can comprise a metal wire. In another embodiment, a clip can comprise a metallic wire embedded within a polymeric and/or thermoplastic material.

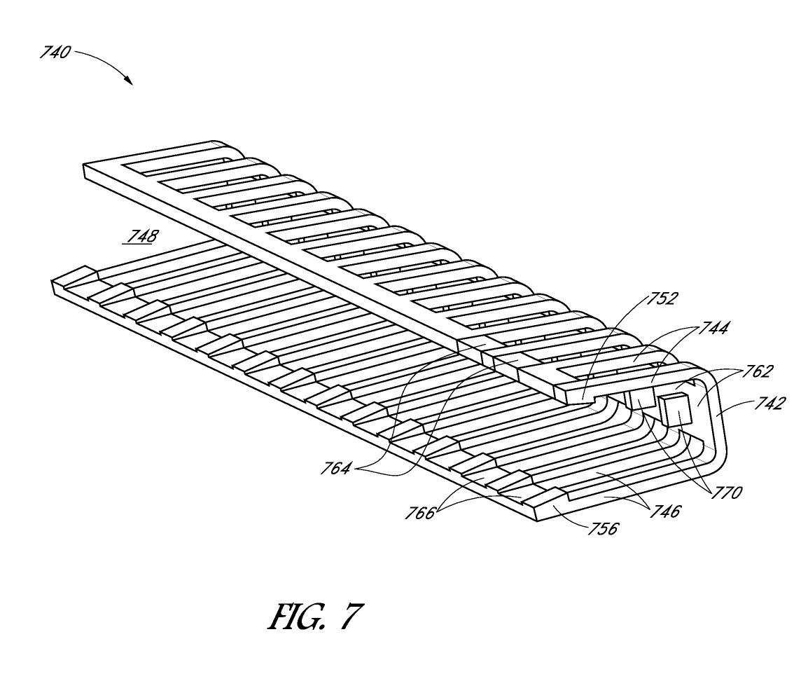

In the embodiment illustrated in FIG. 6, a laminate constraining clip 640 is formed as a metal wire. The laminate-constraining clip 640 comprises a clip mid-section 642, an plurality of upper clip arms 644 and, a plurality of lower clip arms 646. The clip mid-section 642 connects the plurality of upper clip arms 644 to the plurality of lower clip arms 646 to define clip concavity 648. The laminate-constraining clip 640 comprises a mid-section 642 having a sinusoidal shape. Each of the plurality of upper clip arms 644 comprise upper clip arm projections 652. Each of the plurality of lower clip arms 646 comprise a lower clip arm projection 656. As depicted in FIG. 6, the upper clip arm projections 652 and the lower clip projections 656 extend at an approximately 45° angle towards clip concavity 648. However in other embodiments, clip projections can extend at angles greater or less than 45°. In an embodiment, the laminate constraining clip 640 engages the PV laminate without damaging a surface or coating of the PV laminate, for example an anti-reflective coating.

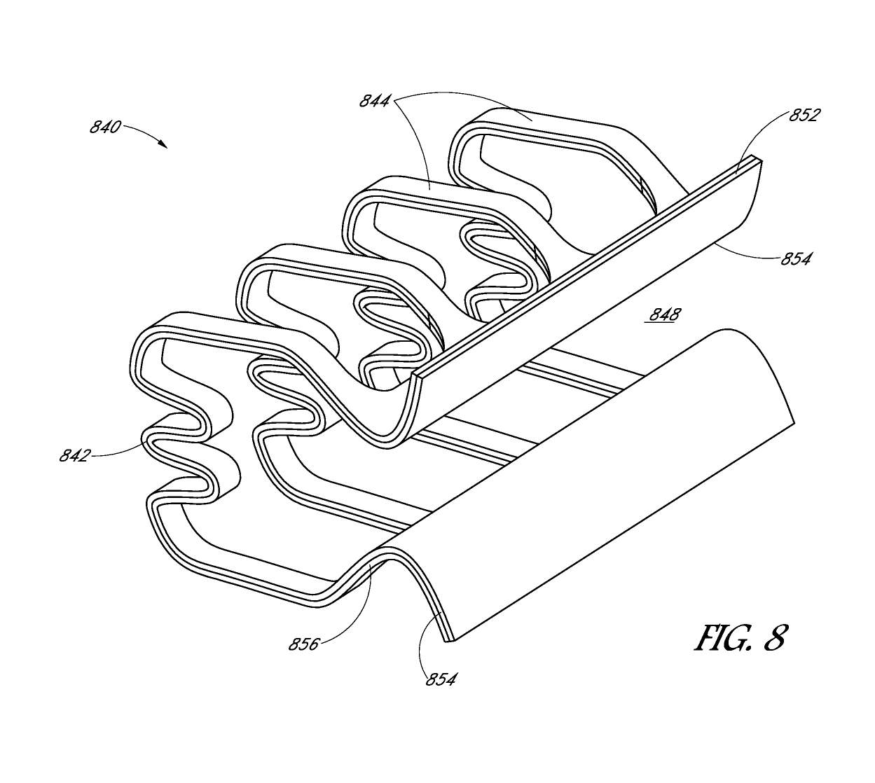

In an embodiment, the clip can comprise a plurality of ribs for connecting a series of upper clip arms, a series of lower clip arms, a series of clip mid-sections, or a combination thereof. In the embodiment depicted in FIG. 7, clip 740 comprises a plurality of clip mid-sections 742, a plurality of upper clip arms 744 and, a plurality of lower clip arms 746. Each clip mid-section 742 connects an upper clip arm 744 to a lower clip arm 746 to define clip concavity 748. Mid-section ribs 762 connect clip mid-sections 742, upper ribs 764 connect upper clip arms 744, and lower ribs 766 connect lower clip arms 746.

In some embodiments, clips can comprise projections originating from a clip mid-section. In the example of FIG. 7, clip 740 comprises mid-section projections 770 extending towards the clip concavity 748. In one embodiment, clip projections can extend from upper and/or lower clip arms towards a clip concavity. In the example of FIG. 7, upper clip arm projection 752 and lower clip arm projection 754 are angled projections directed towards clip concavity 748.

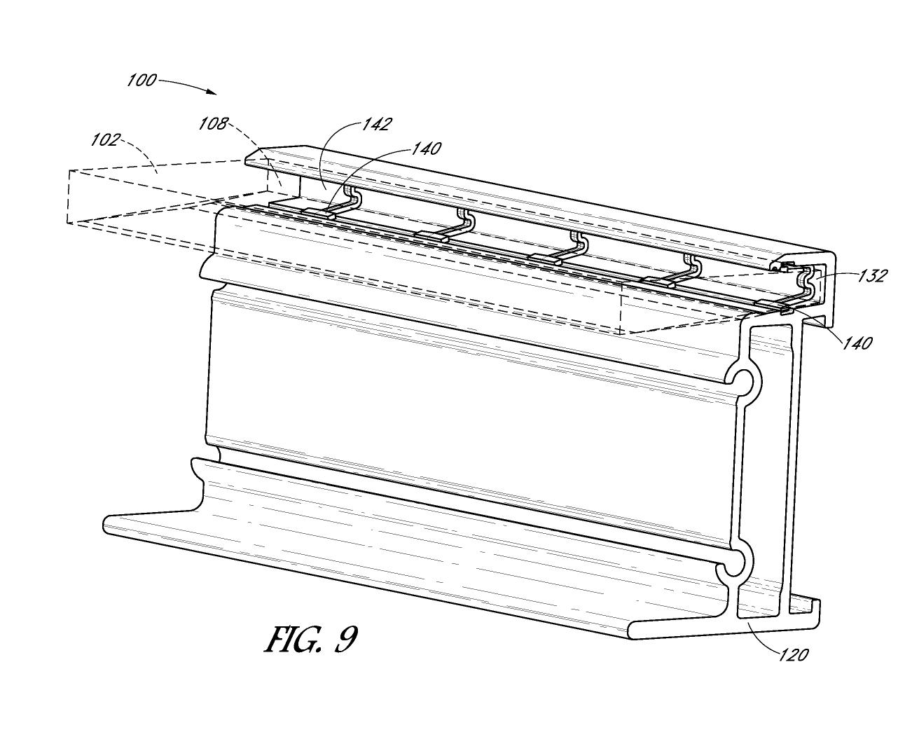

In the embodiment depicted in FIG. 8, clip 840 comprises a plurality of clip mid-sections 842, a plurality of upper clip arms 844 and, a plurality of lower clip arms 846. Each clip mid-section 842 connects an upper clip arm 844 to a lower clip arm 846 to define clip concavity 848. The laminate-constraining clip 840 comprises a plurality of clip mid-sections 842 having a sinusoidal shape. The clip 840 comprises curved projections 852, 854 extending from upper and lower clip arms, respectively. In the example of FIG. 8, upper clip arm projections 852 and lower clip arm projections 854 are curved such that the crests of the curves 854, 856 are directed towards clip concavity 848.

In an embodiment, laminate-constraining clips comprise a polymeric material. For example, clips can comprise materials selected from the group of: polyethylene (PE). polypropylene (PP), polystyrene (PS), polyphenylene oxide (PPO), polyvinyl chloride (PVC), polyetherether ketone (PEEK), polyamides, polycarbonates, acetal resins, acrylonitrile butadiene styrene (ABS) resins, their derivatives or combinations thereof. In one embodiment, a clip comprises a thermosetting polymer. In some embodiments, a clip comprises a thermoplastic material. Extrusion and/or injection molding manufacturing processes can be employed for production of the clip.

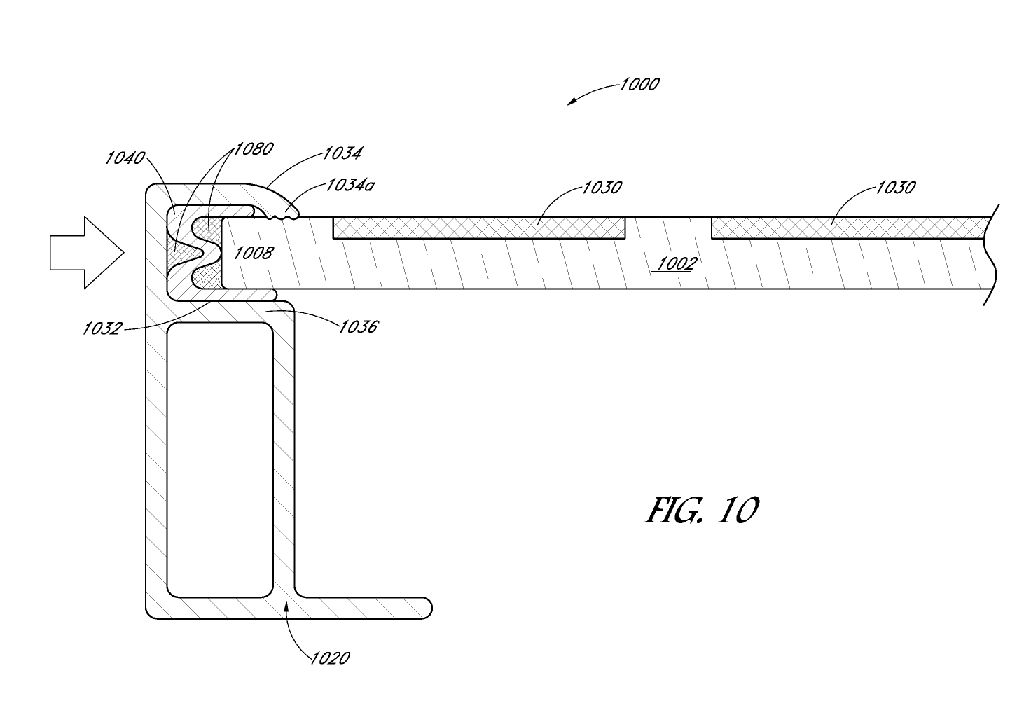

A cross-sectional view of a section of PV module 100 is depicted in FIG. 9. Laminate-constraining clips 140 are nested within the laminate-receiving channel recess 132 of frame 120. In the example of FIG. 9, five laminate-constraining clips 140 are depicted, however any desired number of laminate-constraining clips may be provided. A portion of the peripheral edge 108 of the PV laminate 102 rests within the concavity 148 of laminate-constraining clips 140. The peripheral edge 108 of the PV laminate 102 extends into the channel recess 132 such that the PV laminate 102 is mounted, or seated, in frame 120.

In an embodiment, an adhesive bonds a PV laminate, a clip and a frame to form a PV module. FIG. 10 depicts a cross-sectional view of a PV module 1000 comprising a PV laminate 1002 mounted with a frame 1020. A peripheral edge 1008 of the PV laminate 1002 is situated within a concavity of a clip 1040. The clip 1040 is nested in a channel recess 1032 of frame 1020. An adhesive 1080 partially surrounds the clip 1040 and bonds the PV laminate 1002, the clip 1040 and the frame 1020. FIG. 10 depicts a substantially planar channel recess 1032 and an upper channel flange 1034 comprising a lip 1034a to capture an upper surface of PV laminate 1002.

In one embodiment, an adhesive comprises a silicone sealant or rubber, for example RTV (room temperature vulcanization) silicone or other silicone-based sealant. In some embodiments, the adhesive can be an epoxy. For example, the adhesive can be a B-stage epoxy. In some embodiments, the adhesive can be an adhesive film or tape. In one embodiment, the adhesive film or tape can be rolled in the channel recess.

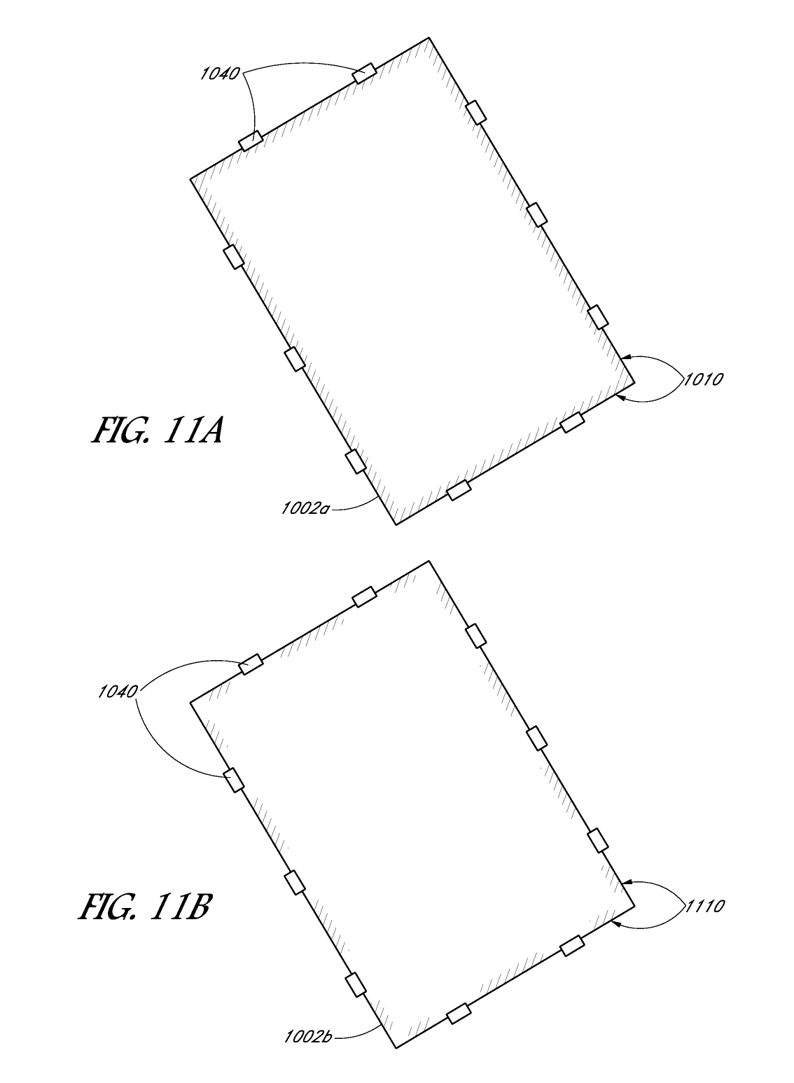

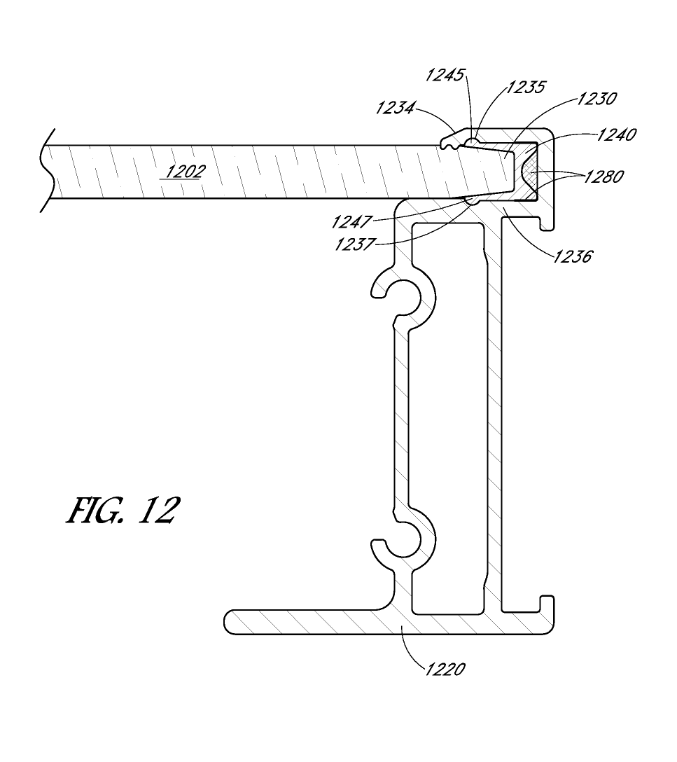

In some embodiments, an adhesive can be provided in predetermined regions or sections of a PV laminate and/or frame. The predetermined regions at which adhesive is provided can vary depending on the application, desired degree of adhesion, desired extent of sealing, PV module or laminate design, and/or particular manufacturing approach. In some embodiments, the adhesive extends substantially continuously along a perimeter of the PV laminate within a channel recess of the frame. In the example of FIG. 11A, adhesive 1180 extends substantially continuously along a perimeter 1110 of PV laminate 1102 comprising laminate constraining clips 1140.

In other embodiments, a plurality of discrete adhesive regions extend along a perimeter of a PV laminate within a channel recess. In one embodiment, adhesive regions can extend in alternating sections of the PV laminate perimeter. For example, a plurality of adhesive regions 1182 can be provided in alternating sections between a series of clips 1140 along a perimeter 1110 of PV laminate 1102 as depicted in FIG. 11B.

In some embodiments, the adhesive can flow from initial regions at which the adhesive is provided. For example, the adhesive can be dispensed at a first region and flow to form an expanded region, thereby encompassing or retaining a clip, a peripheral edge of a PV laminate, or a combination thereof. In one embodiment, clip projections can direct the adhesive regions into desired locations and or inhibit displacement of adhesives (e.g. emerging, flowing and/or oozing to undesired locations) during a manufacturing stage e.g. bonding a PV laminate to a support structure, or frame. In one embodiment, the adhesive contacts both a frame and a PV laminate. In some embodiments the adhesive contacts a frame, a PV laminate and at least one clip.

In an embodiment, the clip is coupled to a support structure, or frame, by an interference fit such that the external dimension of a clip slightly exceeds the internal dimension of a channel. For example, referring again to FIG. 2, the difference between the channel height H and clip distance D can he greater than 0.1 mm, wherein the clip distance D is defined as distant between the upper and lower clip arms in an uncompressed state.

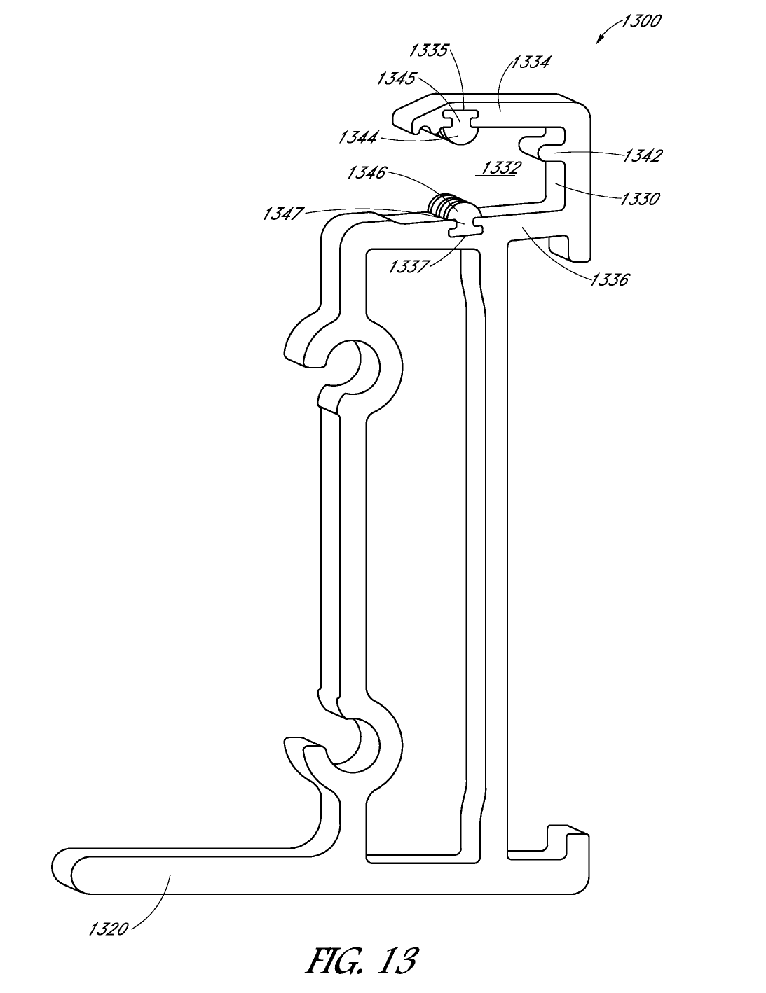

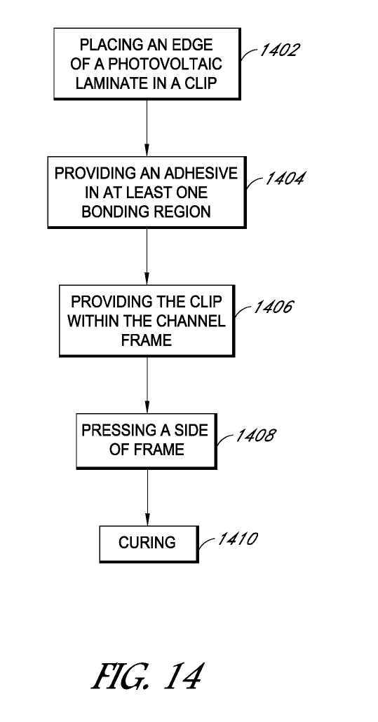

In some embodiments, the clip is coupled to a support structure, or frame, by a snap fit. For example, the frame can comprise a surface feature and the clip can comprise an interlocking feature for coupling the clip to the frame. In the embodiment illustrated in. FIG. 12, the laminate-receiving channel 1230 comprises notches 1235, 1237 at inner surfaces of upper and lower flanges 1234, 1236. The clip 1240 comprises protrusions 1245, 1247 sized to fit within the notches 1235, 1237. The clip protrusions 1245, 1257 extend into notches 1235, 1237 of channel 1230, thereby coupling the clip 1240 to the frame 1220 by a snap fit. As depicted in FIG. 12, the surface features for coupling a clip to a frame are generally rounded, however any desirable shape or structure can be provided. In some embodiments, laminate-constraining features can be integrally formed with, or part of a support structure. In one embodiment, both laminate-constraining features formed as part of a frame and laminate-constraining features formed separately from the frame can be provided within a frame channel. In the embodiment depicted in FIG. 13, PV module 1300 comprises a frame 1320 with a channel 1330. The channel 1330 comprises an upper channel flange 1334 and a lower channel flange 1336 defining a channel recess 1332. A mid-section constraining feature 1342 extends towards channel recess 1332. The laminate-constraining feature 1342 is formed as part of the frame 1320. A plurality of upper constraining features 1344 are positioned within channel recess 1332 at upper channel flange 1334. A plurality of lower constraining features 1346 are positioned within channel recess 1332 at lower channel flange 1336. In the depicted embodiment of FIG. 13, the mid-section constraining feature 1342 is integrally formed with frame 1320. In other embodiments, a mid-section constraining feature can be formed separately from the frame, for example such as upper and lower constraining features 1344, 1346 which are formed separately from the frame and can be coupled the frame. The upper and lower constraining features 1344, 1346 each comprise a protrusion 1345, 1347. The upper and lower channel flanges 1334, 1336 each comprise a recessed surface feature 1335, 1337. The protrusions 1345, 1347 of the upper and lower channel flanges extend into the surface features 1335, 1337 of the channel.

In some embodiments, the clip is coupled to a support structure, or frame, by a snap fit. For example, the frame can comprise a surface feature and the clip can comprise an interlocking feature for coupling the clip to the frame. In the embodiment illustrated in FIG. 12, the laminate-receiving channel 1230 comprises notches 1235, 1237 at inner surfaces of upper and lower flanges 1234, 1236. The clip 1240 comprises protrusions 1245, 1247 sized to fit within the notches 1235, 1237. The clip protrusions 1245, 1257 extend into notches 1235, 1237 of channel 1230, thereby coupling the clip 1240 to the frame 1220 by a snap fit. As depicted in FIG. 12, the surface features for coupling a clip to a frame are generally rounded, however any desirable shape or structure can be provided.

In an embodiment, a clip can be integrally formed with a frame. For example, the frame and clip can be manufactured concurrently as a single piece via extrusion, injection molding, casting, forging or other desired manufacturing method. In other embodiments, the clip is manufactured separately from the frame and the clip is coupled to the frame and/or PV laminate in a separate step. For example, a plurality of clips can be attached to peripheral edges of a PV laminate. Subsequently, the PV laminate comprising the plurality of clips can be mounted into a support structure, or frame.

Laminate-constraining devices, or clips, can inhibit physical deformation (e.g. warping, bending, bowing, cracking, shattering) of a PV laminate, ensure proper alignment of a PV laminate with a mounting structure, and/or facilitate bonding of a PV laminate to a support structure. In addition to the physical characteristics of laminate-constraining clips, PV module manufacturing methods using laminate-constraining clips can ensure proper alignment of PV laminate and frame, direct adhesive regions during a curing stage, and ensure a PV laminate is reinforced during mounting to a support structure.

According to an embodiment illustrated in FIGS. 11A and 11B, a PV module may be manufactured by placing a portion of a peripheral edge of a PV laminate in a concavity of a laminate-constraining clip at step 1102. At step 1104, an adhesive can be provided in at least one predetermined adhesive bonding region. The at least one predetermined bonding region can be within the frame, along a peripheral edge of the PV laminate, at the clip, or a combination thereof. A plurality of bonding regions can be provided substantially continuously along the perimeter of a PV laminate or can be provided in an alternating manner between a plurality of clips. In one embodiment, the adhesive can be partially cured. At 1106, the peripheral edge of the PV laminate and laminate-constraining clip can be at least partially nested within a channel of a frame. At 1108, at least one side of the frame can be manually or mechanically pressed to nest the peripheral edge of the PV laminate and the clip into the channel of the frame.

In one embodiment, the laminate-constraining clip can be first coupled to the frame, or be integrally formed with the frame. An adhesive can then be provided in at least one predetermined adhesive bonding region within a channel portion of the frame, along a peripheral edge of a PV laminate, at the clip, or a combination thereof. This step can then be followed by pressing a portion of the frame toward the peripheral edge of the laminate to seat the laminate into the channel comprising the nested clip. In another embodiment, the laminate-constraining clip can be coupled to the frame by snapping into the channel, sliding into the frame at a corner edge, or any other desired insertion method. At step 1110, the adhesive can be cured to bond the laminate to the channel portion of the frame such that the laminate constraining clip inhibits displacement of the adhesive during photovoltaic module manufacturing and transportation. In one embodiment, curing the adhesive comprises heating.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown can include some or all of the features of the depicted embodiment. For example, elements can be omitted or combined as a unitary structure, and/or connections can be substituted. Further, where appropriate, aspects of any of the examples described above can be combined with aspects of any of the other examples described to form further examples having comparable or different properties and/or functions, and addressing the same or different problems. Similarly, it will be understood that the benefits and advantages described above can relate to one embodiment or can relate to several embodiments. For example, embodiments of the present methods and systems can be practiced and/or implemented using different structural configurations, materials, and/or control manufacturing steps. The claims are not intended to include, and should not be interpreted to include, means-plus- or step-plus-function limitations, unless such a limitation is explicitly recited in a given claim using the phrase(s) “means for” or “step for,” respectively.

1. A photovoltaic (PV) module comprising:
a PV laminate comprising a plurality of PV cells configured into a PV cell string, the PV laminate having peripheral edges defining a laminate perimeter;
a frame comprising:
a lower base portion; and
an upper portion comprising a laminate-receiving channel, the laminate-receiving channel comprising:
an upper channel flange;
a lower channel flange; and
a channel recess defined between the upper and lower channel flanges, wherein a peripheral edge of the PV laminate extends into the channel recess;
a laminate-constraining clip comprising:
a clip mid-section;
an upper clip arm; and,
a lower clip arm, the clip mid-section connecting the upper clip arm to the lower clip arm to define a clip concavity, the laminate-constraining clip nested within the laminate-receiving channel recess, and wherein a section of a peripheral edge of the PV laminate rests within the clip concavity; and
an adhesive within the channel recess and at least partially surrounding the laminate-constraining clip, the adhesive bonding the PV laminate to the frame.

2. The PV module of claim 1, wherein the laminate-constraining clip comprises an arm projection.

3. The PV module of claim 6, wherein the at least one arm projection extends parallel to a peripheral edge of the PV laminate.

4. The PV module of claim 1, wherein the channel recess comprises a notch, and the laminate-constraining clip comprises a protrusion sized to fit within the notch, and the protrusion extends into the notch of the channel.

5. A photovoltaic (PV) module comprising:
a first frame member, wherein the first frame member comprises a channel, the channel comprising:
an upper channel flange; and
a lower channel flange, where the upper and lower channel flanges define a channel recess;
a clip comprising:
a clip mid-section;
an upper clip arm; and,
a lower clip arm, the clip mid-section connecting the upper clip arm to the lower clip arm to define a clip concavity, the clip being nested within the channel recess;
a PV laminate having a peripheral edge, wherein at least a portion of the peripheral edge extends into the clip concavity;
an adhesive within the channel of the frame, the adhesive bonding the frame member, clip, and PV laminate.

6. The PV module of claim 5, wherein the clip is integrally formed within the laminate-receiving channel of the frame.

7. The laminate-constraining clip of claim 5, wherein the laminate-constraining clip comprises a thermoplastic material.

8. The laminate-constraining clip of claim 7, wherein the laminate-constraining clip comprises a metallic wire embedded within the thermoplastic material.

9. The PV module of claim 5, wherein the clip comprises a compressible feature for engaging the clip within the channel recess.

10. The PV module of claim 9, wherein the compressible feature is a compressible polymer material, a sinusoidal wire, a coil spring, or a combination thereof.

11. The PV module of claim 5, wherein the channel has a surface feature and the clip comprises an interlocking feature for coupling the surface feature to the frame.

12. The laminate-constraining clip of claim 5, wherein mid-section comprises a sinusoidal shape.

13. The laminate-constraining clip of claim 5, wherein the laminate-constraining clip further comprises at least one arm projection extending from the upper clip arm, the lower clip arm, or a combination thereof.

14. The laminate-constraining clip of claim 5, wherein the laminate-constraining clip further comprises a plurality of ribs for connecting a series of upper clip arms, a series of lower clip arms, a series of clip mid-sections, or a combination thereof.

15. The PV module of claim 5, wherein:
the channel has a channel height;
the upper clip arm and the lower clip arm in an uncompressed state are separated by a clip distance; and
the difference between the channel height and the clip distance is greater than 0.1 mm.

16. The PV module of claim 5, wherein the adhesive extends substantially continuously along a perimeter of the PV laminate.

17. The PV module of claim 5, wherein the adhesive extends in alternating sections between a series of clips within the channel.

18. The photovoltaic module of claim 5, wherein the channel of the frame comprises surface features selected from the group of longitudinally extending ridges, sinusoidal cross sections, and saw-tooth cross sections.

19. A PV module comprising:
a first frame member, wherein the first frame member comprises a channel, the channel comprising:
an upper channel flange; and
a lower channel flange, where the upper and lower channel flanges define a channel recess;
a mid-section constraining feature within the channel recess;
an upper constraining feature within the channel recess at the upper channel flange; and,
a lower constraining feature within the channel recess at the lower channel flange,
a PV laminate having a peripheral edge, wherein at least a portion of the peripheral edge extends into the channel recess;

20. The PV module of claim 19, wherein the upper and lower channel flanges each comprise a surface feature, the upper and lower constraining features each comprise a protrusion, and the protrusions of the upper and lower channel flanges extend into the surface features of the channel.
